(19) United States
(12) Patent Application Publication
(10) Pub. No.: US 2025/0290792 A1
(43) Pub. Date: Sep. 18, 2025

(54) SYSTEMS AND METHODS FOR CONTACTLESS OPTICAL FIBER SIGNAL DETECTION

(71) Applicant: EXFO INC., Quebec (CA)

(72) Inventors: Alexandre DRAPEAU, Ancienne-Lorette (CA); Michel LECLERC, Quebec (CA); Olivier COTE, Quebec (CA)

(21) Appl. No.: 19/077,631

(22) Filed: Mar. 12, 2025

Related U.S. Application Data
(60) Provisional application No. 63/565,779, filed on Mar. 15, 2024.
(60) Provisional application No. 63/667,393, filed on Jul. 3, 2024.

(51) Int. Cl. G01J 1/04; G01J 1/02

(52) U.S. Cl. CPC G01J 1/0411; G01J 1/0271; G01J 1/0403; G01J 1/0488; G01J 2001/0276

(57) ABSTRACT

Systems and methods for contactless identification of an optical fiber under test (FUT) are disclosed. System embodiments include an optical power meter and an optical accessory. The power meter can include a casing, a detection port extending through the casing, and a photodetector optically coupled to the detection port within the casing. The accessory can include a housing and a focusing lens. The housing extends between an attachment end and a testing end, and encloses an interior region defining an optical pathway. The attachment end is releasably connected to the detection port, while the testing end is configured to be positioned at a testing distance from the FUT and allow fiber light emanating from the FUT to enter the optical pathway via free-space propagation. The focusing lens is positioned within the housing along the optical pathway and configured to direct the fiber light onto the photodetector through the detection port.

### CROSS-REFERENCE TO RELATED APPLICATIONS

This application claims priority under 35 U.S.C. § 119(e) to U.S. Provisional Patent Application Ser. No. 63/565,779, filed on Mar. 15, 2024, and U.S. Provisional Patent Application Ser. No. 63/667,393, filed on Jul. 3, 2024, both of which are incorporated herein in their entireties by reference.

### TECHNICAL FIELD

The technical field pertains to optical fiber testing, and more specifically to systems and methods designed for contactless optical fiber identification and signal detection.

### BACKGROUND

Optical fiber networks are fundamental components of modern telecommunication systems and infrastructures. Maintaining the integrity and efficiency of signal transmission within these networks necessitates the development of reliable, precise, and field-adapted techniques for optical fiber testing. These techniques encompass a range of procedures including fiber inspection, fiber identification, optical power measurements, and optical loss measurements.

Fiber identification, which is employed throughout the network's lifecycle from initial deployment to ongoing maintenance, encounters significant challenges, especially within complex networks and shared facilities used by multiple operators, such as fiber cabinets, distribution hubs, and drop terminals. Although existing fiber identification techniques are available, they exhibit drawbacks and limitations. These include the necessity for fiber inspection and cleaning prior to fiber identification testing, the utilization of time-intensive and repetitive testing methods, the reliance on additional and often costly test equipment, an increased risk of fiber contamination due to multiple fiber connection and disconnection steps, as well as the limitation that certain techniques require operational networks, thereby preventing their use during network deployment. Consequently, challenges remain in the development of fiber identification techniques for discerning and detecting optical signals within optical fibers.

### SUMMARY

The present description concerns systems and methods designed for contactless optical fiber identification and signal detection, offering a free-space, open-beam approach to capturing and detecting light emitted by a fiber under test (FUT).

In accordance with an aspect, there is provided a testing system for contactless identification of an optical fiber under test (FUT), including:
an optical power meter including:
   a casing;
   a detection port extending through the casing; and
   a photodetector optically coupled to the detection port within the casing; and
an optical accessory including:
   a housing extending between an attachment end and a testing end, the housing enclosing an interior region defining an optical pathway therethrough, wherein the attachment end is releasably connected to the detection port, and wherein the testing end is configured to be positioned at a testing distance from the FUT and allow fiber light emanating from the FUT to enter the optical pathway via free-space propagation; and
   a focusing lens positioned within the housing along the optical pathway and configured to direct the fiber light onto the photodetector through the detection port to detect the fiber light for identification of the FUT.

In some embodiments, the testing distance ranges from about 1 mm to about 60 cm.

In some embodiments, the fiber light has a wavelength within a range from about 800 nm to about 1625 nm.

In some embodiments, the attachment end is configured for releasable connection to the detection port via a threaded connection, a snap-fit connection, a slip-fit connection, a bayonet connections, a screw connection, a spring-loaded connection, a magnetic-coupling connection, a clamp connection, or a latch connection.

In some embodiments, the FUT is inserted within a fiber adapter including a protective shutter, and the fiber light passes through the protective shutter for reaching the optical pathway.

In some embodiments, the FUT is a non-connectorized fiber, such as a bare fiber that is cleaved and ready to be fused, or a fiber that is cut after breakage. As a result, fiber light emanating from the core of the fiber may enter the optical pathway of the accessory via free-space propagation.

In some embodiments, the FUT is inserted within a fiber adapter including a protective shutter, and the optical accessory includes a pushing protrusion at the testing end, the pushing protrusion being configured to engage the protective shutter into an open position to allow the fiber light to escape from within the fiber adapter and enter the optical pathway.

In some embodiments, the testing system further includes a spectral filter positioned within the housing in front of the focusing lens, and the spectral filter is configured to transmit the fiber light within a specified spectral band. In some embodiments, the spectral filter is configured to block visible ambient light.

In some embodiments, the focusing lens is positioned within the housing in a recessed manner to reduce an amount of ambient light allowed to reach the focusing lens.

In some embodiments, the testing system further includes a control and processing unit coupled to the photodetector and including a processor and a non-transitory computer readable storage medium having stored thereon computer readable instructions that, when executed by the processor, cause the processor to analyze the fiber light detected by the photodetector and derive therefrom fiber identification information associated with the FUT. In some embodiments. the fiber identification information associated with the FUT includes at least one of: (i) an assessment as to whether the FUT is an active or inactive fiber, (ii) a determination of a power level associated with the fiber light, (iii) an identification of a wavelength of the fiber light, and (iv) a detection of a tone signal at a specific modulation frequency within the fiber light.

In accordance with another aspect, there is provided an optical accessory for use with an optical power meter for contactless identification of an optical fiber under test (FUT), the optical power meter including a casing; a detection port extending through the casing; and a photodetector optically coupled to the detection port within the casing, the optical accessory including:
a housing extending between an attachment end and a testing end, the housing enclosing an interior region defining an optical pathway therethrough, wherein the attachment end is configured for releasable connection to the detection port, and wherein the testing end is configured to be positioned at a testing distance from the FUT and allow fiber light emanating from the FUT to enter the optical pathway via free-space propagation; and
a focusing lens positioned within the housing along the optical pathway and configured to direct the fiber light onto the photodetector through the detection port for the photodetector to detect the fiber light for identification of the FUT.

In some embodiments, the attachment end is configured for releasable connection to the detection port via a threaded connection, a snap-fit connection, a slip-fit connection, a bayonet connections, a screw connection, a spring-loaded connection, a magnetic-coupling connection, a clamp connection, or a latch connection.

In some embodiments, the FUT is inserted within a fiber adapter including a protective shutter, and the optical accessory includes a pushing protrusion at the testing end, the pushing protrusion being configured to engage the protective shutter into an open position to allow the fiber light to escape from within the fiber adapter and enter the optical pathway.

In some embodiments, the optical accessory further includes a spectral filter positioned within the housing in front of the focusing lens, and the spectral filter is configured to transmit the fiber light within a specified spectral band. In some embodiments, the spectral filter is configured to block visible ambient light.

In some embodiments, the focusing lens is positioned within the housing in a recessed manner to reduce an amount of ambient light allowed to reach the focusing lens.

In accordance with another aspect, there is provided a testing method for contactless identification of an optical fiber under test (FUT), including:
providing an optical power meter and an optical accessory, wherein the optical power meter includes a casing, a detection port extending through the casing, and a photodetector optically coupled to the detection port within the casing, and wherein the optical accessory includes a housing and a focusing lens, the housing extending between an attachment end and a testing end and enclosing an interior region defining an optical pathway therethrough, and the focusing lens being positioned within the housing along the optical pathway;
connecting the attachment end of the optical accessory to the detection port of the optical power meter;
positioning the testing end of the optical accessory at a testing distance from the FUT;
allowing fiber light emanating from the FUT to enter the optical pathway through the testing end via free-space propagation;
directing, with the focusing lens, the fiber light onto the photodetector through the detection port; and
detecting, with the photodetector, the fiber light for identification of the FUT.

In some embodiments, the testing distance ranges from about 1 mm to about 60 cm.

In some embodiments, the fiber light has a wavelength within a range from about 800 nm to about 1625 nm.

In some embodiments, connecting the attachment end to the detection port including using one of the following types of connections: a threaded connection, a snap-fit connection, a slip-fit connection, a bayonet connections, a screw connection, a spring-loaded connection, a magnetic-coupling connection, a clamp connection, or a latch connection.

In some embodiments, the FUT is inserted within a fiber adapter including a protective shutter, and the fiber light passes through the protective shutter before reaching the optical pathway.

In some embodiments, the FUT is inserted within a fiber adapter including a protective shutter, and allowing the fiber light emanating from the FUT to enter the optical pathway through the testing end includes engaging the protective shutter with a pushing protrusion provided at the testing end to move the protective shutter into an open position to allow the fiber light to escape from within the fiber adapter and enter the optical pathway.

In some embodiments, the FUT is part of an optical fiber array, and positioning the testing end includes scanning the testing end over the optical fiber array to detect the fiber light from the FUT.

In some embodiments, the optical fiber array is part of a path panel.

In some embodiments, the testing method further includes using a spectral filter positioned within the housing in front of the focusing lens to transmit the fiber light within a specified spectral band. In some embodiments, the testing method further includes using the spectral filter to block visible ambient light.

In some embodiments, providing the optical accessory includes positioning the focusing lens within the housing in a recessed manner to reduce an amount of ambient light allowed to reach the focusing lens.

In some embodiments, the testing method further includes analyzing the fiber light detected by the photodetector and deriving therefrom fiber identification information associated with the FUT. In some embodiments, the fiber identification information includes at least one of: (i) assessing whether the FUT is an active or inactive fiber, (ii) determining a power level associated with the fiber light, (iii) identifying a wavelength of the fiber light, and (iv) detecting a tone signal at a specific modulation frequency within the fiber light.

In accordance with another aspect, there is provided a kit for contactless identification of an optical fiber under test (FUT), including:
an optical power meter including:
   a casing;
   a detection port extending through the casing; and
   a photodetector optically coupled to the detection port within the casing; and
an optical accessory including:
   a housing extending between an attachment end and a testing end, the housing enclosing an interior region defining an optical therethrough, wherein the attachment end is configured for releasable connection to the detection port, and wherein the testing end is configured to be positioned at a testing distance from the FUT and allow fiber light emanating from the FUT to enter the optical pathway via free-space propagation; and
   a focusing lens positioned within the housing along the optical pathway and configured to direct the fiber light onto the photodetector through the detection port to detect the fiber light for identification of the FUT.

Other method and process steps may be performed before, during, or after the steps described herein. The order of one or more steps may also differ, and some of the steps may be omitted, repeated, and/or combined, as the case may be. It is also to be noted that some steps may be performed using various analysis and processing techniques, which may be implemented in hardware, software, firmware, or any combination thereof.

Other objects, features, and advantages of the present techniques will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIGS. 1 to 14 depict various aspects, features, and implementations of, or related to, the techniques disclosed herein.

FIG. 1 is a schematic perspective view of an embodiment of a testing system for the identification of a fiber under test (FUT). The testing system includes an optical power meter and a releasably connected optical accessory.

FIG. 2 is another schematic perspective view of the testing system shown in FIG. 1, showing the optical accessory disconnected from the optical power meter.

FIG. 3 is another schematic perspective view of the testing system shown in FIG. 1.

FIG. 4 is a schematic cross-sectional side elevation view of the testing system shown in FIG. 1.

FIG. 5 is a schematic perspective view of another embodiment of a testing system for the identification of a FUT, where the FUT is an un-connectorized fiber.

FIG. 6 is a schematic perspective view of another embodiment of a testing system for the identification of a FUT, where the system is operated in a fiber-connected mode.

FIG. 7 is a schematic perspective view of an embodiment of an optical accessory designed for use with an optical power meter for the identification of a FUT.

FIG. 8 is a schematic cross-sectional perspective view of the optical accessory shown in FIG. 7.

FIG. 9 is a schematic cross-sectional side elevation view of another embodiment of a testing system for the identification of a FUT.

FIG. 10 is a schematic cross-sectional side elevation view of another embodiment of a testing system for the identification of a FUT.

FIG. 11 is a schematic cross-sectional side elevation view of another embodiment of a testing system for the identification of a FUT.

FIG. 12 is a schematic cross-sectional side elevation view of another embodiment of a testing system for the identification of a FUT, where the FUT is positioned within a fiber adapter among an array of fibers also inserted within adapters.

FIG. 13 is a schematic cross-sectional side elevation view of another embodiment of a testing system for contactless identification of a FUT, where the FUT is positioned within a fiber adapter among an array of fibers also inserted within adapters and emits fiber light modulated with a lower-frequency tone signal.

FIG. 14 is another schematic cross-sectional side elevation view of the testing system show in FIG. 13, where the system has been moved closer to the fiber array.

### DETAILED DESCRIPTION

The present description pertains to systems and methods designed for contactless optical fiber identification and signal detection. The disclosed techniques provide a free-space, open-beam approach to capturing and detecting light emitted by a fiber under test (FUT). Notably, the present techniques can be executed without physically manipulating the FUT, such as by establishing a fiber-optic connection between the FUT and the testing system. By offering a contactless method for fiber identification, the disclosed techniques enable quicker and easier testing procedures, reducing the risk of fiber contamination arising from multiple fiber connection and disconnection steps.

The disclosed techniques generally involve coupling a specially designed optical accessory to the detection port of an optical power meter. This accessory typically includes a housing with a hollow interior defining an optical pathway. Positioned within this pathway is a focusing lens configured to collect free-space-propagating fiber light emitted from a FUT and direct the collected light onto the power meter's photodetector for detection and fiber identification. To enhance contactless fiber identification at a distance, the testing system may use an accessory with a wide capture angle and an open-beam power meter with a large photosensitive area.

In some instances, the optical power meter, which can be a conventional model for optical signal detection and/or characterization using fiber connections, can operate in two modes: a standard fiber-connected mode without the accessory and a contactless mode with the accessory. Selective attachment or detachment of the accessory enables convenient switching between the two modes. In certain cases, the accessory is designed for compatibility with a wide range of commercially available power meters.

The systems and methods disclosed herein are adaptable for testing various optical fiber setups, installations, and identification scenarios. In certain instances, the FUT may consist of an individual fiber, whether single-mode or multimode, terminated with a fiber connector or not. Different types of fiber connectors (e.g., SC, ST, FC, LC, MDC, SN, CS, MTP/MPO, SN-MT, and MMC) and end face interfaces (e.g., PC, APC, UPC) may be utilized. In other instances, the FUT may be a connector-terminated fiber inserted into a fiber adapter, a common setup found within patch panels housing arrays of fiber adapters.

In some other cases, the FUT may consist of one or more un-connectorized fibers with exposed cores, which can be due to various causes, including a broken fiber and a bare fiber that has been cleaved and is ready to be fused. Such fibers may be single-mode or multimode, and are commonly found in sizes such as jacketed fiber (3 mm), buffered fiber (900 μm), coated fiber (250 μm), and ribbon fiber.

Disclosed fiber identification scenarios include identifying active or inactive fibers, detecting specific signal characteristics within active fibers, and distinguishing an active fiber among inactive ones, and vice versa. The disclosed techniques contemplate contactless scanning of the testing system in front of fiber arrays for fiber light identification. In some setups, this scanning process applies to fibers within adapters with protective shutters, provided the shutter allow the fiber light wavelength to pass therethrough.

The disclosed techniques can find utility across a wide range of applications where contactless fiber characterization is beneficial or necessary. For instance, the present techniques can be employed in various types of optical communication networks, including metro, long-haul, and submarine systems, as well as diverse environments, such as field-deployed networks, manufacturing facilities for network equipment, research and development laboratories, and data centers. Additionally, the disclosed techniques can prove valuable during the installation, activation and/or operation phases of an optical communication network, facilitating characterization, maintenance, error diagnosis, troubleshooting, and monitoring tasks. Depending on the specific application requirements, the disclosed techniques can be integrated with portable or fixed test instruments.

Further aspects and implementations of the present techniques will be presented below with reference to the accompanying figures.

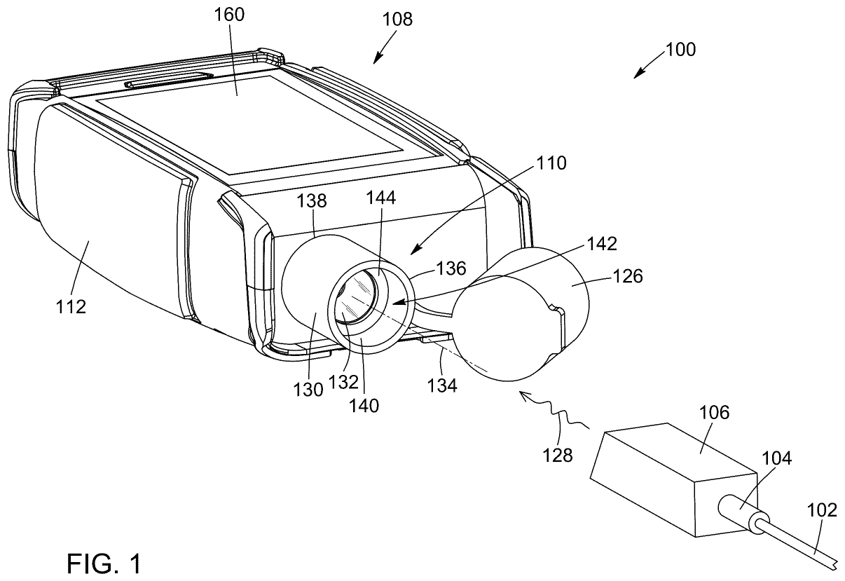

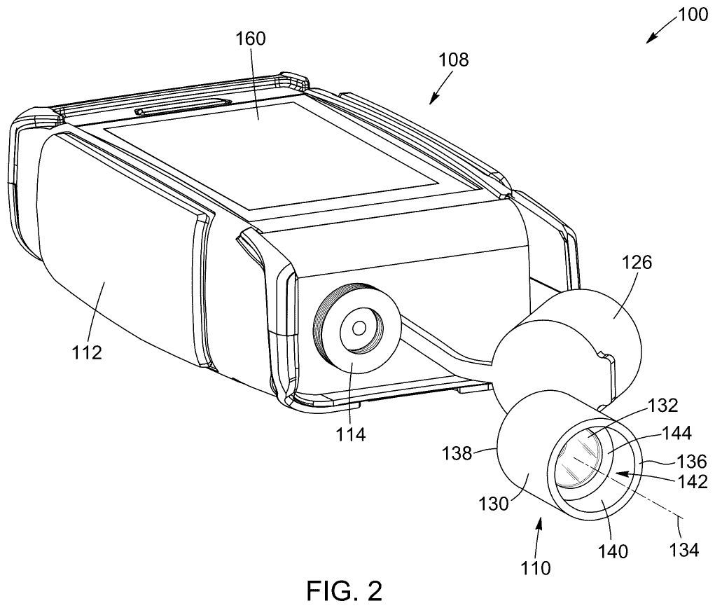

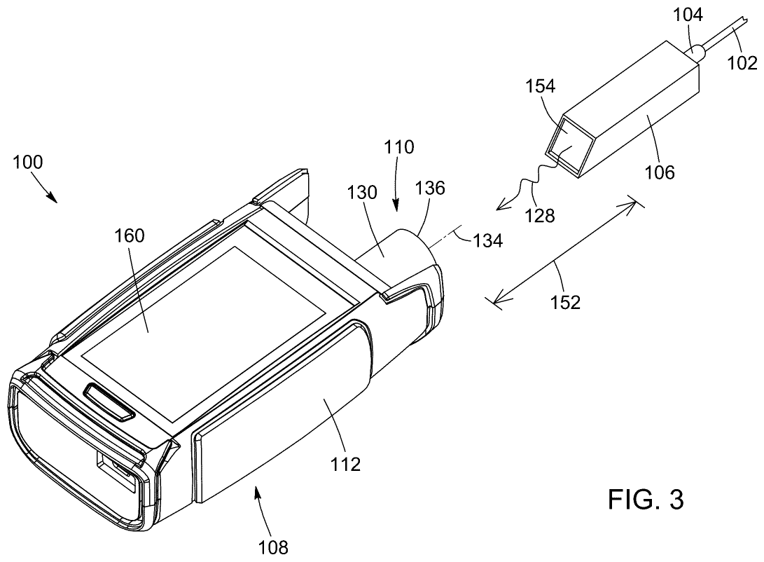

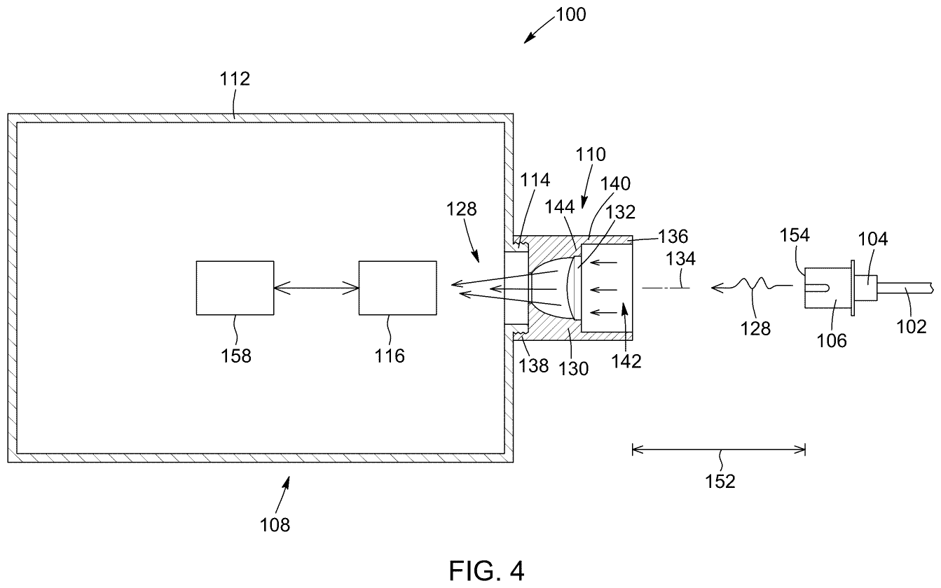

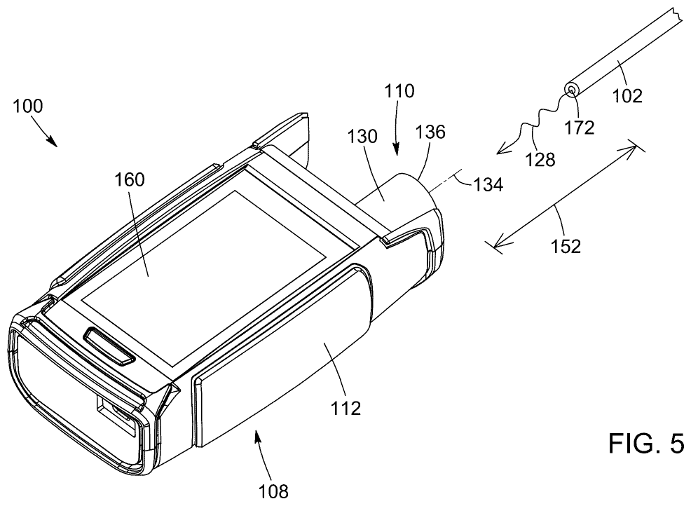

Referring to FIGS. 1 to 4, an embodiment of a testing system 100 for contactless identification of a FUT 102 is depicted. In this setup, the FUT 102 is inserted into a fiber connector 104, which in turn is housed within a fiber adapter 106. However, neither of these conditions is mandatory. For instance, in certain setups, the FUT 102 may be an un-connectorized fiber with an exposed core 172, as depicted in FIG. 5. Additionally, while a single FUT 102 is represented in FIGS. 1 to 5 for simplicity, the present techniques can be applied in environments such as patch panels featuring a large number of closely spaced optical fibers, as described in more details below.

The testing system 100 shown in FIGS. 1 to 4 includes an optical power meter 108 and an optical accessory 110, which are connected in a releasable manner. In certain embodiments, the testing system 100 may be manufactured and sold as a complete fiber testing instrument or as a kit containing both the power meter 108 and the accessory 110. Alternatively, the optical accessory 100 may be manufactured and sold separately as a standalone unit compatible with a range of commercially available power meters from one or more manufacturers. Additional details regarding the structure, configuration, and operation of these and other possible components of the testing system 100 are provided in the following description. It is appreciated that FIGS. 1 to 4, as well as other figures described later on, are schematic representations aiming to illustrate a number of components and features of the testing system 100. Therefore, additional components and features that may be useful or necessary for practical operation may not be specifically depicted.

The optical power meter 108 includes a casing 112, a detection port 114 extending through the casing 112, and a photodetector 116 optically coupled to the detection port 114 within the casing 112.

The casing 112 defines the overall structure of the power meter 108, housing and protecting the photodetector 116 and any additional internal components. The casing 112 is typically made of sturdy materials such as molded plastic or lightweight metals. In the illustrated embodiment, the casing 112 has a substantially rectangular prismatic configuration, although alternative arrangements are possible. Depending on the intended application or specific requirements, the power meter 108 can be provided in portable or fixed instrument configurations. In certain embodiments, the power meter 108 can feature a compact, handheld form factor suitable for field testing. Alternatively, the power meter 108 may be set up in a stationary configuration, enabling integration into larger testing systems or laboratory settings. The power meter 108 can be powered in various ways, including by batteries, whether rechargeable or disposable, external power adapters, or standard power sources commonly found in fiber testing environments. Additionally, certain implementations of the power meter 108 can incorporate wireless communication capabilities to enhance operational flexibility by allowing remote monitoring and data transfer.

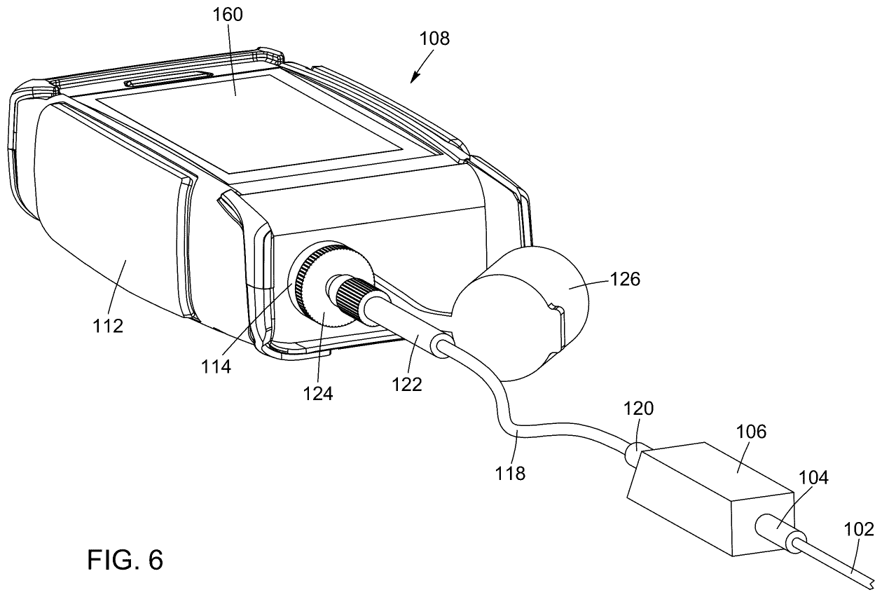

The detection port 114 can be designed with various configurations to facilitate connection with the optical accessory 110. In certain embodiments, the power meter 108 may be capable of conducting fiber identification testing not only in a contactless mode with the accessory 110 attached, but also in a fiber-connected mode, without the accessory 110. In some instances, the fiber-connected mode might serve as the standard or default mode for the power meter 108. During this operational mode, fiber testing can be carried out by connecting a fiber to the detection port 114 using a suitable fiber adapter. This connected fiber could either be the FUT 102 itself or an intermediary coupling fiber. An illustration of the latter scenario is depicted in FIG. 6, where a coupling fiber 118 with fiber connectors 120, 122 at both ends is utilized. One connector 120 is coupled within the fiber adapter 106 housing the FUT 102, while the other connector 122 is coupled within a fiber adapter 124 attached to the detection port 114. This setup offers versatility in testing configurations. For instance, it can accommodate scenarios where utilizing the fiber-connected mode might not be practical or preferable. Transitioning from the fiber-connected mode depicted in FIG. 6 to the contactless mode depicted in FIGS. 1 to 4 may simply require disconnecting the fiber adapter 124 from the detection port 114 and connecting the accessory 110 in its place. Such a configuration can streamline the process of switching between different testing setups. In the illustrated embodiment, the power meter 108 is equipped with a protective cap 126 that can be placed over the detection port 114 when not in use to provide protection and help ensure cleanliness.

Returning to FIGS. 1 to 4, the photodetector 116 can be embodied by any optical detector or combination of optical detectors capable of performing optical power measurements within the wavelength range of the fiber light 128 received from the FUT 102. In some embodiments, the fiber light 128 has a wavelength within a range from about 800 nm to about 1625 nm, encompassing the C-band from 1530 nm to 1565 nm and the L-band from 1565 nm to 1625 nm, as well as multimode spectral bands at about 850 nm and 1300 nm, although wavelength values outside these ranges are possible. The photodetector 116 receives the incoming fiber light 128 and converts it into electrical signals representative of the detected light. These electrical signals undergo signal processing within the power meter 108 to generate power level readings. Examples of photodetector technologies include PIN photodiodes, avalanche photodiodes, and Schottky photodiodes. The selection of the photodetector 116 can be made based on the specific measurement requirements, such as the power levels, wavelength range, measurement speed, and sensitivity.

In some embodiments, the photodetector 116 is configured for measuring optical power in a non-spectrally resolved manner. In such instances, optical power measurements yield single-value responses, averaged or integrated over a wavelength range corresponding to the detection spectral range of the photodetector 116 (or the signal bandwidth, whichever is narrower). Alternatively, the photodetector 116 in other embodiments may provide spectral information in addition to power measurements. In such cases, the photodetector 116 may be configured to perform power measurements at different wavelengths within a specific range or to select specific wavelengths and measure their power levels individually.

It should be noted that the optical power meter 108 in FIGS. 1 to 4 is configured to use open-beam detection in both the contactless mode and the fiber-connected mode. In the present description, open-beam detection means that after light enters the detection port 114, whether through the optical accessory 110 in the contactless mode (FIGS. 1 to 4) or the coupling fiber 118 in the fiber-connected mode (FIG. 6), it follows a free-space path to the photodetector 116, either directly or through relay optics such as lenses, mirrors, and filters. An advantage of such open-beam power meters is their capability to feature photodetectors with larger photosensitive surface areas.

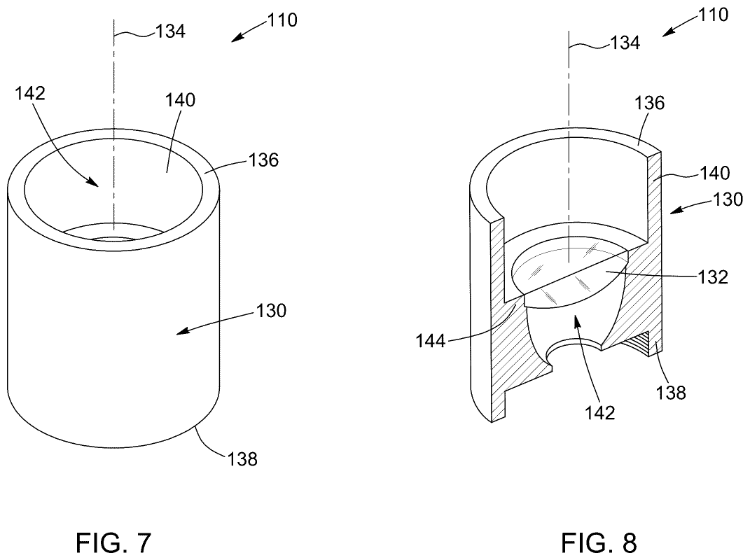

Returning to FIGS. 1 to 4, and also referring to FIGS. 7 and 8, the optical accessory 110 includes a housing 130 and a focusing lens 132 positioned within the housing 130. The housing 130 defines the overall structure of the accessory 110, supporting and safeguarding the focusing lens 132 and any additional components. The housing 130 is typically made of sturdy materials such as molded plastic or lightweight metals. The housing 130 extends along a housing axis 134 between a testing end 136 and an attachment end 138. The housing 130 includes a sidewall 140 enclosing an interior region that defines an optical pathway 142 within the housing 130, enabling light propagation between the testing end 136 and the attachment end 138. Both ends 136, 138 are constructed as end walls with openings that provide optical access through the optical pathway 142. In the illustrated embodiment, the housing 130 has a substantially cylindrical configuration about the housing axis 134, although alternative shapes and arrangements are possible. In some embodiments, the axial extent of the housing 130 along the housing axis 134 can range from about 15 mm to about 30 mm, while the lateral extent transverse to the housing axis 134 can range from about 10 mm to about 25 mm. However, the housing dimensions and shape can be adjusted to specific application needs. For instance, in certain cases, the axial extent of the housing 130 may be selected based on the focal length of the focusing lens 132 to ensure that fiber light 128 is properly focused on the photodetector 116 upon connection of the accessory 110 to the power meter 108.

The attachment end 138 is designed for a secure yet easily detachable connection to the detection port 114 of the power meter 108. Various fastening mechanisms can serve this purpose, including threaded connections, snap-fit connections, slip-fit connections, bayonet connections, screw connections, spring-loaded connections, magnetic-coupling connections, clamp connections, and latch connections. Using a secure connection while allowing for quick, easy and tool-free attachment and detachment proves advantageous in some instances.

The housing 130 includes a lens holder 144 configured to support the focusing lens 132 during operation. The lens holder 144 may take the form of a lens-receiving cavity or seat within the sidewall 140, providing space for inserting and securely affixing the focusing lens 132. In some instances, the housing configuration may permit easy removal and replacement of the focusing lens 132. In some embodiments, a modular construction of the housing 130 can offer advantages in terms of ease of assembly and disassembly, maintenance, design flexibility, and scalability.

The focusing lens 132 is configured to receive the fiber light 128 emitted from the FUT 102 and direct it onto the photodetector 116. This can be achieved either directly, with the photodetector 116 typically positioned at or near the focal point of the focusing lens 132, or indirectly through relay optics within the power meter's casing 112, between the detection port 114 and the photodetector 116. In the illustrated embodiment, the axis of the focusing lens 132 is colinear with the housing axis 134, but this is not a strict requirement.

Depending on the intended application or specific requirements, the focusing lens 132 may be a single lens or a compound lens (a collection of single lenses aligned along a shared axis). Additionally, the focusing lens 132 can be made from various materials with specific optical properties, including glass and plastic materials. Suitable lens materials for telecommunication wavelengths in the near-infrared range include fused silica, crown glass (e.g. N-BK7), flint glass (e.g., N-SF11), calcium fluoride, magnesium fluoride, polymethyl methacrylate (PMMA), and polycarbonate.

The focusing lens 132 may exhibit a spherical or aspherical profile and adopt diverse configurations, such as biconvex, plano-convex, concave-convex, or ball lenses. In some embodiments, the focusing lens 132 may possess a diameter ranging from about 5 mm to about 20 mm, with a focal length range from 5 mm to 20 mm. In certain cases, applying an anti-reflective coating to the focusing lens 132 may enhance performance by reducing undesired reflections.

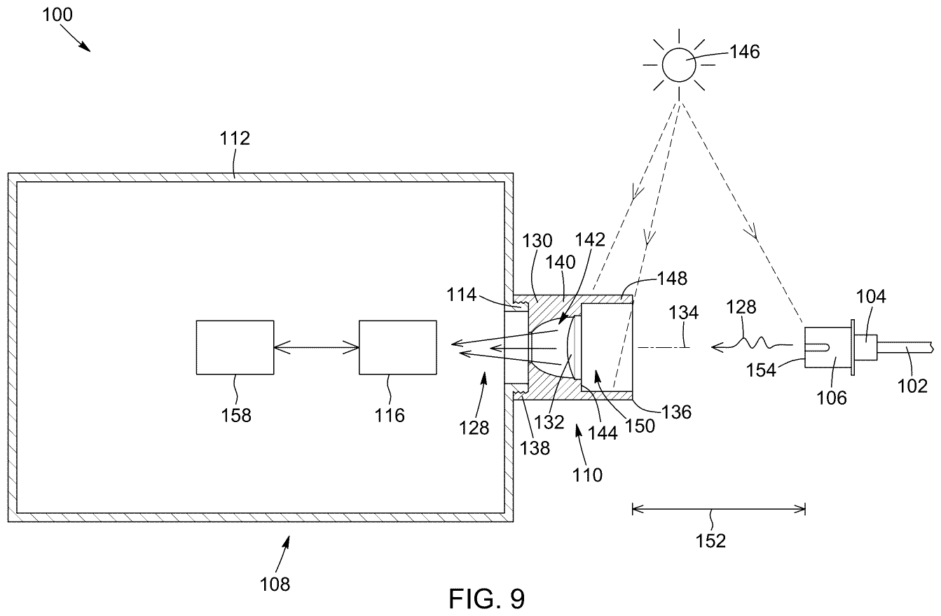

In some embodiments, the focusing lens 132 is positioned within the housing 130 in a recessed manner, establishing a standoff distance from the testing end 136 of the accessory 110. As depicted in FIG. 9, this positioning can reduce the collection of ambient light 146 by the focusing lens 132 and prevent its redirection onto the photodetector 116. Uncontrolled ambient light 146 could interfere with the fiber light 128 emitted from the FUT 102, complicating measurement and analysis. This is depicted in FIG. 9, where an occluding section 148 of the housing's sidewall 140, extending from the lens holder 144 to the testing end 136, blocks ambient light 146, creating a shadow zone 150 in front of the focusing lens 132 that the ambient light 146 cannot reach. By appropriately designing the occluding section 148, adverse effects caused by ambient light 146 can be lessened while still preserving a sufficiently wide capture angle for the fiber light 128. It is noted that while this recessed configuration of the focusing lens 132 may limit the distance from which fiber testing can be performed with the accessory 110, the advantage of mitigating ambient light effects may outweigh this limitation. It is also noted that other approaches can be used to reduce ambient light interference. One possible approach can involve positioning an ambient light blocking structure (not shown) in front of the focusing lens 132. For instance, this structure can be implemented as a shade screen featuring an array of openings defining a grid pattern (e.g., a honeycomb pattern). The structure can be mounted at the testing end 136 of the accessory 110 to prevent unwanted ambient light 146 from affecting fiber light measurements.

Returning to FIGS. 1 to 4, the operation of the testing system 100 can include steps of (i) providing the optical power meter 108 and the optical accessory 110, (ii) connecting the attachment end 138 of the accessory 110 to the detection port 114 of the power meter 108; (iii) positioning the testing end 136 of the accessory 110 at a testing distance 152 from the FUT 102; (iv) allowing fiber light 128 emanating from the FUT 102 to enter the optical pathway 142 through the testing end 136 via free-space propagation; (v) directing, with the focusing lens 132, the fiber light 128 onto the photodetector 116 through the detection port 114; and (vi) detecting, with the photodetector 116, the fiber light 128 for identification of the FUT 102.

In some embodiments, the testing distance 152 can range from about 1 mm to about 60 cm, although values outside this range are also possible.

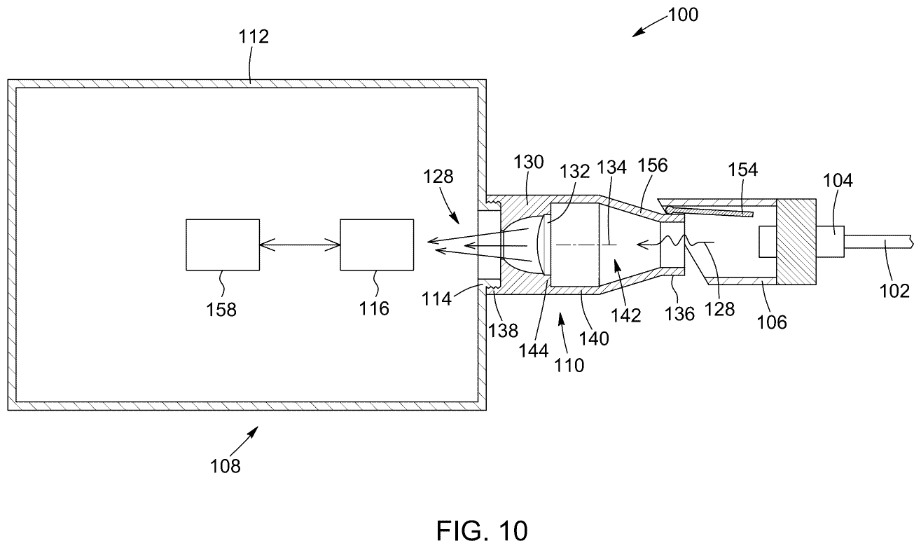

In certain configurations, the FUT 102 is inserted within a fiber adapter 106 that includes a protective shutter 154, and the fiber light 128 is permitted to pass through the protective shutter 154 and reach the testing system 100. However, in other configurations, the protective shutter 154 may not be transparent to the fiber light 128. In such cases, the step of allowing the fiber light 128 from the FUT 102 to enter the optical pathway 142 through the testing end 136 may involve engaging the protective shutter 154 to move it into an open position to allow the fiber light 128 to escape from within the fiber adapter 106 and enter the optical pathway 142. An example of this arrangement is shown in FIG. 10. In this embodiment, the optical accessory 110 is equipped with a pushing protrusion 156 at the testing end 136. The pushing protrusion 156 is designed to engage the protective shutter 154 of the fiber adapter 106, pushing it into its open position to allow optical access to the FUT 102 therewithin. In the depicted embodiment, the pushing protrusion 156 begins with a tapered section followed by a straight section of reduced diameter compared to that of the main section of the housing 130. It is noted that the construction of the pushing protrusion 156 shown in FIG. 10 is for illustrative purposes, and other embodiments may feature pushing protrusions or similar structures with various shapes and configurations.

The provision of the pushing protrusion 156 can be advantageous when the material of the protective shutter 154 is opaque to the wavelength of the fiber light 128, which is often the case when the protective shutter 154 is made of metal or a black or dark plastic material. This design allows the protective shutter 154 to be opened without manual manipulation, thus facilitating a contactless fiber identification process. Such a design offers convenience and efficiency in scenarios where quick and reliable optical access to the FUT 102 is beneficial or needed.

Returning to FIGS. 1 to 4, the method can also involve analyzing the fiber light 128 detected by the photodetector 116 to derive fiber identification information associated with the FUT 102. The derived fiber identification can vary based on the application requirements and may include (i) assessing whether the FUT 102 is an active or inactive fiber, (ii) determining the power level associated with the fiber light 128, (iii) identifying the wavelength of the fiber light 128, and (iv) detecting a tone signal at a specific modulation frequency (e.g., in the kilohertz range) within the fiber light 128. It is appreciated that the principles underlying the processing and analysis of optical power measurements for fiber testing to derive fiber light information about a FUT are generally known in the art and need not be described in detail herein, except to facilitate an understanding of the present techniques.

In some embodiments, the testing system 100 includes a control and processing unit 158 responsible for managing and coordinating the operation of the power meter 108 and any additional connected components. The control and processing unit 158 is configured to receive and analyze detection signals from the photodetector 116 to extract fiber identification information concerning the detected fiber light 128 from the FUT 102. Additionally, the control and processing unit 158 can present the fiber identification information to the user as visual or audible signals.

When the accessory 110 is connected to the power meter 108, certain functions or parameters typically displayed in its standard or default operation mode without the accessory 110 may not be applicable. In these instances, the control and processing unit 158 can execute dedicated software associated with the contactless operation mode and programmed to provide specific details, such as signal presence or absence, signal strength, wavelength, and tone detection. In some embodiments, the accessory 110 may include an RFID tag or another suitable component designed to automatically switch the power meter 108 to a contactless operation mode upon connection to ensure seamless operation, notably when the accessory 110 includes spectral filtering capabilities (see below). The RFID tag can store data associated with these capabilities, reducing the need for manual adjustments of the power meter settings to wavelength parameters specific to the accessory 110.

In the illustrated embodiment, the control and processing unit 158 is fully integrated within the power meter 108. However, alternative embodiments may feature partial integration or physical separation of the control and processing unit 158 from the power meter 108. The control and processing unit 158 typically includes one or more processors and memories, implemented in hardware, software, firmware, or any combination thereof. The control and processing unit 158 can provide signal and data transmission through wired or wireless communication links, and can be operated via direct user input and/or programmed instructions.

In some instances, the optical power meter 108 may be equipped with one or more user interfaces operatively connected to the control and processing unit 158. These interfaces can include input devices such as touch screens and control buttons, as well as output devices such as display screens and visual or audible indicators. These devices enable users to input commands and queries, and receive the corresponding results. In certain scenarios, the power meter 108 may present the detected fiber identification information on a display screen 160. Additionally, some embodiments allow for the transmission of fiber identification information through audible notifications, which is beneficial in situations where the display screen 160 is not visible or easily accessible. In certain cases, the audible notifications can be emitted at a volume proportional to the strength of the detected optical signal to serve as an indicator of the fiber's proximity.

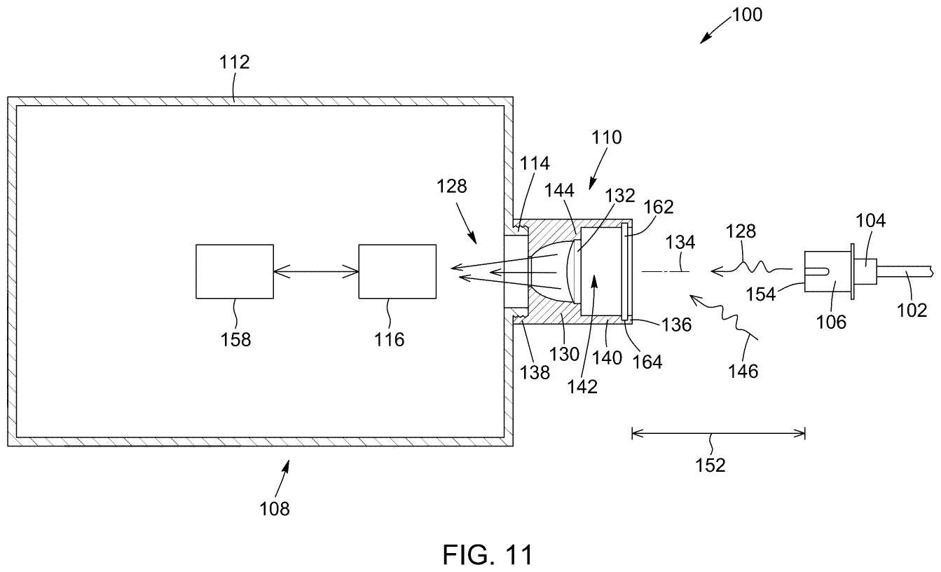

Referring to FIG. 11, another embodiment of a testing system 100 for contactless fiber identification is depicted. This embodiment shares several features with previously discussed embodiments. These features will not be described again in detail, except to highlight differences between them. In the embodiment of FIG. 11, the accessory 110 includes a spectral filter 162 positioned in front of the focusing lens 132 within the housing 130. The spectral filter 162 is designed to selectively filter the fiber light 128 based on specific spectral characteristics. In some embodiments, the spectral filter 162 can be embodied as a spectrally filtering lens, for example, a lens coated with an optical coating designed with specific transmission characteristics. The spectrally filtering lens may exhibit a spherical or aspherical profile and adopt diverse configurations, such as biconvex, plano-convex, concave-convex, or ball lenses. In other embodiments, the spectral filter 162 can be provided as an optical window or thin film. The spectral filter 162 can be secured in place by a corresponding filter holder 164 integrated within the housing 130, such as a filter-receiving cavity or seat. In certain configurations, the spectral filter 162 can be positioned in a slightly recessed manner within the housing 130 to provide protection and help ensure cleanliness. Additionally, while the spectral filter 162 is positioned in front of the focusing lens 132 in FIG. 11, in other variants the spectral filter 162 may be disposed behind the focusing lens 132.

In some embodiments, the spectral filter 162 functions as a bandpass filter, allowing only wavelengths within a defined range to pass while effectively blocking those outside of it. In certain cases, the spectral filter 162 may be a broadband bandpass filter configured to transmit wavelengths covering relevant telecommunication wavebands. For instance, the spectral filter 162 may be configured to transmit the fiber light 102 in a specified spectral band covering a range from about 1500 nm to about 1650 nm, to encompass the C-band and the L-band, or a range of about 780 nm to about 1650 nm, to encompass multimode bands (850/1300 nm), in addition to the C-band and the L-band. Furthermore, when configured to reject visible light, the spectral filter 162 can effectively block or attenuate a significant portion of ambient light 146 before it reaches the focusing lens 132. In these cases, the spectral filter 162 offers an additional approach to mitigate undesirable ambient light effects, which can be employed as an alternative to or in combination with the previously discussed strategy of positioning the focusing lens 132 sufficiently deep within the housing 130, as depicted in FIG. 9.

In other cases, the spectral filter 162 can have a narrower passband (e.g., of the order of 10 nm), selectively transmitting only one or a few specific telecommunication wavelengths while blocking others. This capability enables discrimination between optical signals corresponding to different passive optical network (PON) technologies, such as XGS-PON (1577 nm), GPON (1490 nm), RF Video/RFoG (1550 nm), and 25G-PON (1358 nm). Incorporating such a filter makes it feasible to identify the PON technologies deployed within an operational network without the need for direct fiber connection.

In certain embodiments, the spectral filter 162 can have a tunable bandwidth, enabling adjustment by the user according to the wavelength of the fiber light 128 carried by the FUT 102 or other specific requirements or changing conditions. In other instances, the spectral filter 162 can be conveniently removed and replaced by another filter possessing distinct spectral characteristics. In such cases, the accessory 110 can be provided with a corresponding set of spectral filters covering distinct wavelength bands, allowing for customization based on the user's needs or the optical network's characteristics. In some instances, such a set of spectral filters may be integrated within the housing 130, and selection of the specific filter to be positioned in the optical path of the fiber light 102 can be achieved through mechanical positioning adjustment (e.g., by rotation or translation of the spectral filters). In yet other setups, the optical accessory 110 may exhibit spectral filtering capabilities provided by the focusing lens 132 itself rather than by an additional, distinct component, such as the spectral filter 162 of FIG. 11.

The disclosed techniques are applicable to various scenarios of fiber identification and signal detection, including the identification of active or inactive fibers, the detection of specific signal characteristics within active fibers, and the discrimination of an active fiber among inactive ones, and vice versa.

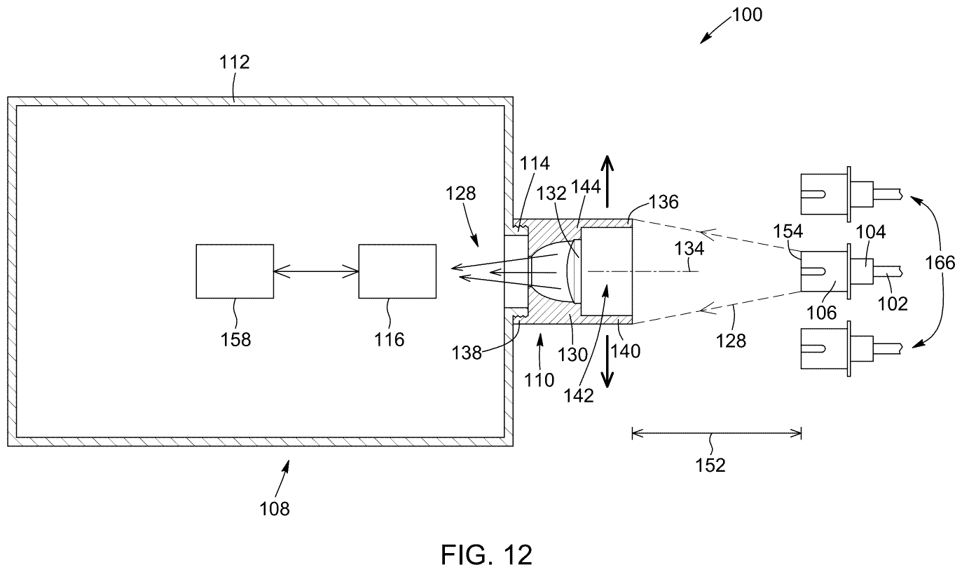

FIG. 12 depicts an example where a FUT 102 is positioned within a fiber adapter 106 among an array of fibers 166, also inserted within adapters. In this example, the FUT 102 is active, while the other fibers 166 are inactive. The process of identifying the FUT 102 as active may involve scanning the testing system 100 across the array until the fiber light 128 emanating from the FUT 102 is captured by the accessory 110 and directed onto the power meter's photodetector 116 for detection and fiber identification.

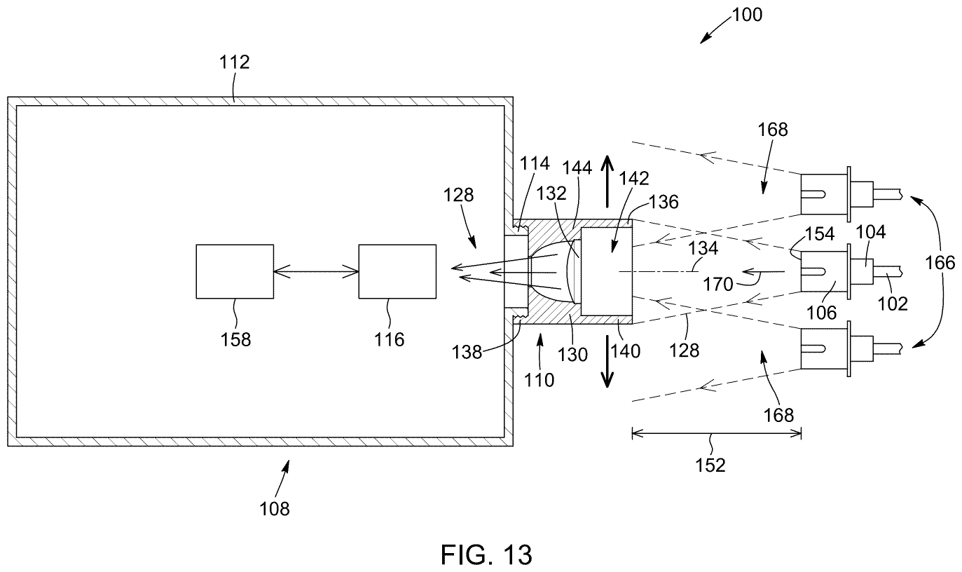

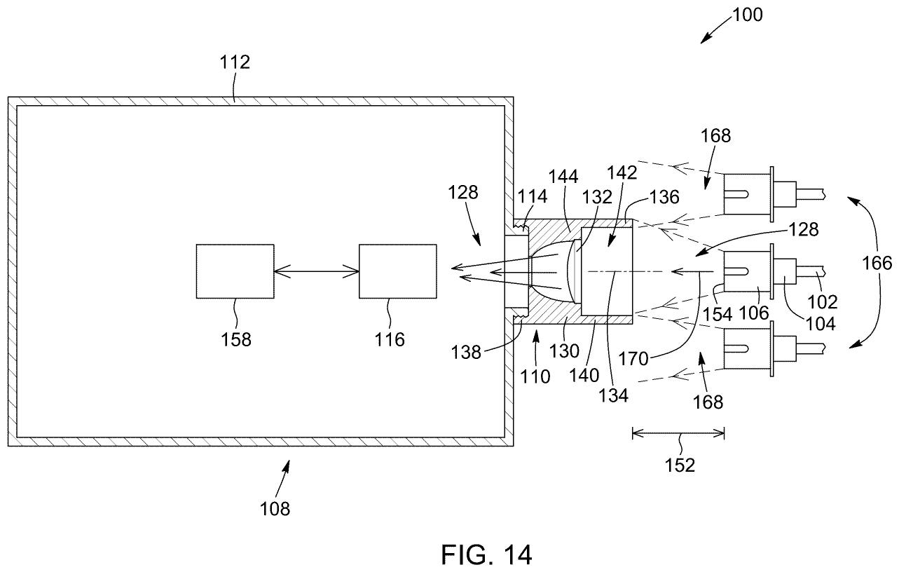

FIGS. 13 and 14 illustrate a scenario wherein a FUT 102 emits fiber light 128 modulated with a specific lower-frequency tone signal (e.g., in the kHz range). Tone signals are often intentionally added to fiber light signals for purposes such as signal identification (e.g., identifying specific channels or components within an optical fiber network) and troubleshooting (e.g., identifying network issues such as signal interference and faulty components). As in FIG. 12, the FUT 102 is part of a patch panel containing multiple other fibers 166 arranged in an array. To identify the FUT 102 carrying the tone signal 170, the testing system 100 can be scanned across the array until the light 128 emitted from the FUT 102 is captured by the accessory 110 and directed onto the power meter's photodetector 116 for detection and analysis. Techniques for extracting tone signals are known in the art and need not be described herein.

In FIG. 13, the testing system 100 scans the fiber array at an initial testing distance 152 (e.g., 15 cm). At this distance, the testing system 100 captures not only the fiber light 128 from the FUT 102 but also the fiber light 168 from neighboring active fibers 166, allowing for rapid simultaneous scan of several fibers. The neighboring fibers 166 emit fiber light 168 carrying standard, tone-free signals, while the FUT 102 emits fiber light 128 modulated with a low-frequency tone signal 170 for detection. In FIG. 14, the testing system 100 is brought closer to the fiber array (e.g., 5 cm), which increases the strength of the detected tone signal 170 and facilitates the discrimination and identification of the FUT 102 from its neighboring fibers 166.

In the present description, similar features in the drawings have been given similar reference numerals. To avoid cluttering certain figures, some elements may not be indicated if they were already identified in a preceding figure. The elements of the drawings are not necessarily depicted to scale since emphasis is placed on clearly illustrating the elements and structures of the present embodiments. Positional descriptors indicating the location and/or orientation of one element with respect to another element are used herein for ease and clarity of description. Unless otherwise indicated, these positional descriptors should be taken in the context of the figures and should not be considered limiting. In particular, positional descriptors are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined as “and/or”, unless stated otherwise.

Terms such as “substantially”, “generally”, and “about”, which modify a value, condition, or characteristic should be understood to mean that the value, condition, or characteristic falls within acceptable tolerances for the proper functioning of the described embodiment or within an acceptable range of experimental error. In particular, the term “about” generally denotes a range of values that one skilled in the art would consider equivalent to the stated value (e.g., having the same or an equivalent function or result). In some instances, the term “about” means a variation of ±10% of the stated value. It is noted that all numeric values used herein are assumed to be modified by the term “about”, unless stated otherwise. The term “between” refers to a range defined by endpoints, inclusive of both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “from”, “depending on”, “representative of”, “indicative of”, “associated with”, “relating to”, and the like.

The terms “match”, “matching”, and “matched” refer herein to a condition where two elements are either identical or within a predetermined tolerance of each other. These terms encompass not only exact matches but also substantial, approximate, or subjective matches, as well as a best or highest match among various matching possibilities.

The terms “connected” and “coupled”, along with their derivatives and variants, refer herein to any form of connection or coupling, whether direct or indirect, between two or more elements, unless stated otherwise. This connection or coupling can take various forms, including, but not limited to, mechanical, optical, electrical, magnetic, thermal, chemical, logical, fluidic, operational, or any combination thereof.

The term “concurrently” refers herein to the simultaneous or overlapping occurrence of two or more processes. The term “concurrently” does not necessarily imply complete synchronicity but encompasses various scenarios. These scenarios include the simultaneous occurrence of two processes; a first process that both begins and ends during the duration of a second process; and a first process that starts during the duration of a second process but ends after the second process is completed.

The term “measured” when referring to a quantity or parameter is intended to mean that the quantity or parameter can be measured either directly or indirectly. In the case of indirect measurement, the quantity or parameter can be derived, retrieved, inferred or otherwise determined from directly measured data.

The terms “light” and “optical”, along with their variants and derivatives, encompass radiation across any appropriate region of the electromagnetic spectrum. This includes not only visible light but also extends to invisible regions such as the terahertz (THz), infrared (IR), and ultraviolet (UV) spectral bands. For instance, in certain embodiments, the disclosed techniques can be implemented with optical signals having a bandwidth lying within a wavelength band ranging from about 800 nm to about 1625 nm (e.g., the C-band from 1530 nm to 1565 nm, the L-band from 1565 nm to 1625 nm and multimode bands at about 850 nm and 1300 nm). However, it should be noted that this wavelength range is provided for illustrative purposes, and the disclosed techniques may extend beyond this range or cover a narrower range. Furthermore, all descriptions provided herein as a function of wavelength could also be formulated as a function of frequency, wave number, energy, or other pertinent spectral parameters.

The term “active fiber” refers to a fiber that is carrying a signal or emitting light, while the term “inactive fiber” refers to a fiber that is not carrying a signal or emitting light. In some instances, the terms “live fibers” and “lit fibers” can be used to designate active fibers, while the terms “dark fibers” and “unlit fibers” can be used to designate inactive fibers.

The term “processor” as used herein broadly refers to any electronic device, circuitry, or component capable of processing, receiving, or transmitting data or instructions, such as computer programs, commands, functions, processes, software codes, executables, applications, and similar entities. The term “processor” is meant to encompass a single processor or processing unit, multiple processors or processing units, or other suitably configured processing elements. When a processor includes multiple processing elements, the processing elements may be located at a single site or distributed across multiple sites interconnected by a communication network. Examples of communication networks include local area networks (LANs) and wide area networks (WANs) such as the Internet. Non-limiting examples of processors include general-purpose single- or multi-core processors; central processing units (CPUs); microprocessors; controllers; microcontrollers; digital signal processors (DSPs); programmable logic devices; a field-programmable gate arrays (FPGAs); application-specific integrated circuits (ASICs); digital processors or circuits; analog processors or circuits; state machines; and/or any other device capable of processing information.

The term “memory” as used herein broadly refers to any electronic device, circuitry, or component capable of storing electronic data or information. In some instances, the term “memory” may be used interchangeably with the term “computer readable storage medium”. The term “memory” is meant to encompass a single memory or memory unit, multiple memories or memory units, or other suitably configured memory elements. When a memory includes multiple memory elements, these elements may be located at a single site or distributed across multiple sites interconnected by a communication network. Non-limiting examples of memories include random-access memories (RAM) of any type; read-only memories (ROM) of any type; magnetic storage devices; optical storage devices; solid-state drive (SSD) devices, such as flash drive memories; and any other tangible and/or non-transitory computer readable medium capable of storing electronic data or information.

Numerous modifications could be made to the embodiments described above without departing from the scope of the appended claims.

1. A testing system for contactless identification of an optical fiber under test (FUT), comprising:
an optical power meter comprising:
a casing;
a detection port extending through the casing; and
a photodetector optically coupled to the detection port within the casing; and
an optical accessory comprising:
a housing extending between an attachment end and a testing end, the housing enclosing an interior region defining an optical pathway therethrough, wherein the attachment end is releasably connected to the detection port, and wherein the testing end is configured to be positioned at a testing distance from the FUT and allow fiber light emanating from the FUT to enter the optical pathway via free-space propagation; and
a focusing lens positioned within the housing along the optical pathway and configured to direct the fiber light onto the photodetector through the detection port for the photodetector to detect the fiber light for identification of the FUT.

2. The testing system of claim 1, wherein the FUT is inserted within a fiber adapter comprising a protective shutter, and wherein the optical accessory comprises a pushing protrusion at the testing end, the pushing protrusion being configured to engage the protective shutter into an open position to allow the fiber light to escape from within the fiber adapter and enter the optical pathway.

3. The testing system of claim 1, further comprising a spectral filter positioned within the housing in front of the focusing lens, wherein the spectral filter is configured to transmit the fiber light within a specified spectral band.

4. The testing system of claim 3, wherein the spectral filter is configured to block visible ambient light.

5. The testing system of claim 1, wherein the focusing lens is positioned within the housing in a recessed manner to reduce an amount of ambient light allowed to reach the focusing lens.

6. The testing system of claim 1, further comprising a control and processing unit coupled to the photodetector and comprising a processor and a non-transitory computer readable storage medium having stored thereon computer readable instructions that, when executed by the processor, cause the processor to analyze the fiber light detected by the photodetector and derive therefrom fiber identification information associated with the FUT, wherein the fiber identification information associated with the FUT comprises at least one of: (i) an assessment as to whether the FUT is an active or inactive fiber, (ii) a determination of a power level associated with the fiber light, (iii) an identification of a wavelength of the fiber light, and (iv) a detection of a tone signal at a specific modulation frequency within the fiber light.

7. An optical accessory for use with an optical power meter for contactless identification of an optical fiber under test (FUT), the optical power meter comprising a casing; a detection port extending through the casing; and a photodetector optically coupled to the detection port within the casing, the optical accessory comprising:
a housing extending between an attachment end and a testing end, the housing enclosing an interior region defining an optical pathway therethrough, wherein the attachment end is configured for releasable connection to the detection port, and wherein the testing end is configured to be positioned at a testing distance from the FUT and allow fiber light emanating from the FUT to enter the optical pathway via free-space propagation; and
a focusing lens positioned within the housing along the optical pathway and configured to direct the fiber light onto the photodetector through the detection port for the photodetector to detect the fiber light for identification of the FUT.

8. The optical accessory of claim 7, wherein the attachment end is configured for releasable connection to the detection port via a threaded connection, a snap-fit connection, a slip-fit connection, a bayonet connections, a screw connection, a spring-loaded connection, a magnetic-coupling connection, a clamp connection, or a latch connection.

9. The optical accessory of claim 7, wherein the FUT is inserted within a fiber adapter comprising a protective shutter, and wherein the optical accessory comprises a pushing protrusion at the testing end, the pushing protrusion being configured to engage the protective shutter into an open position to allow the fiber light to escape from within the fiber adapter and enter the optical pathway.

10. The optical accessory of claim 7, further comprising a spectral filter positioned within the housing in front of the focusing lens, wherein the spectral filter is configured to transmit the fiber light within a specified spectral band.

11. The optical accessory of claim 10, wherein the spectral filter is configured to block visible ambient light.

12. The optical accessory of claim 5, wherein the focusing lens is positioned within the housing in a recessed manner to reduce an amount of ambient light allowed to reach the focusing lens.

13. A testing method for contactless identification of an optical fiber under test (FUT), comprising:
providing an optical power meter and an optical accessory, wherein the optical power meter comprises a casing, a detection port extending through the casing, and a photodetector optically coupled to the detection port within the casing, and wherein the optical accessory comprises a housing and a focusing lens, the housing extending between an attachment end and a testing end and enclosing an interior region defining an optical pathway therethrough, and the focusing lens being positioned within the housing along the optical pathway;
connecting the attachment end of the optical accessory to the detection port of the optical power meter;
positioning the testing end of the optical accessory at a testing distance from the FUT;
allowing fiber light emanating from the FUT to enter the optical pathway through the testing end via free-space propagation;
directing, with the focusing lens, the fiber light onto the photodetector through the detection port; and
detecting, with the photodetector, the fiber light for identification of the FUT.

14. The testing method of claim 13, wherein the testing distance ranges from about 1 mm to about 60 cm.

15. The testing method of claim 13, wherein the FUT is inserted within a fiber adapter comprising a protective shutter, and wherein the fiber light passes through the protective shutter before reaching the optical pathway.

16. The testing method of claim 13, wherein the FUT is inserted within a fiber adapter comprising a protective shutter, and wherein allowing the fiber light emanating from the FUT to enter the optical pathway through the testing end comprises engaging the protective shutter with a pushing protrusion provided at the testing end to move the protective shutter into an open position to allow the fiber light to escape from within the fiber adapter and enter the optical pathway.

17. The testing method of claim 13, wherein the FUT is part of an optical fiber array, and wherein positioning the testing end comprises scanning the testing end over the optical fiber array to detect the fiber light from the FUT.

18. The testing method of claim 13, further comprising using a spectral filter positioned within the housing in front of the focusing lens to transmit the fiber light within a specified spectral band.

19. The testing method of claim 18, further comprising using the spectral filter to block visible ambient light.

20. The testing method of claim 13, further comprising analyzing the fiber light detected by the photodetector and deriving therefrom fiber identification information associated with the FUT.
